(19) United States
(12) Patent Application Publication
(10) Pub. No.: US 2007/0046615 A1
(43) Pub. Date: Mar. 1, 2007

(54) Liquid crystal panel operating in a frame-inversion driving scheme

(75) Inventors: Shunji Tsuida, Tokyo (JP); Yoshinori Tomihari, Tokyo (JP); Hiroyuki Sekine, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC Corporation, Tokyo (JP)

(21) Appl. No.: 11/513,857

(22) Filed: Aug. 31, 2006

(30) Foreign Application Priority Data
Sep. 1, 2005 (JP) 2005-253274

(51) Int. Cl. G09G 3/36

(52) U.S. Cl. 345/100

(57) ABSTRACT

A LC panel for use in a projection LCD device includes a source driver IC operating in a frame-inversion driving scheme. The luminance gradient caused by the frame-inversion driving scheme in the active-matrix substrate is cancelled by the luminance gradient caused by the heat generated by the source driver. A heat adjusting element is provided for the source driver IC, wherein the heat adjusting element is either a radiator or a heater depending on the relationship of the magnitude between the luminance gradients caused by the frame-inversion driving scheme and the source driver IC.

### BACKGROUND OF THE INVENTION

(a) Field of the Invention

The present invention relates to liquid crystal (LC) panel using a frame-inversion driving scheme and, more particularly, to a LC panel suitably used in a projection-type liquid crystal display (projection LCD) device.

(b) Description of the Related Art

A transmissive LC panel for use in a LCD device using an active-matrix driving scheme includes a TFT (thin-film-transistor) substrate on which an array of pixel electrodes are disposed in association with TFTs, a counter substrate on which a single common electrode is disposed, and a LC layer sandwiched between both the substrates. In the transmissive LC panel, TFTs having a switching function are controlled to apply a desired potential to respective pixel electrodes, whereby the potential difference between the pixel electrodes and the common electrode changes the orientation of the LC molecules in the LC layer and controls the optical transmission factor in the pixels.

On the TFT substrate, there are provided a plurality of source lines for delivering data signals, or gray-scale potentials, to the pixels, and a plurality of scanning lines for delivering switching signals to the TFTs. The scanning lines receive scanning pulse signals from a gate driver, whereas the source lines receive gray-scale potentials from a source driver. If n-type TFTs are used in the LC panel, a high-level scanning signal applied through a scanning line turns ON the TFTs connected to the scanning line, whereby the source lines provide gray-scale potentials to the respective pixel electrodes through these TFTs. When a low-level scanning signal is applied to the TFTs through a scanning line to turn OFF the TFTs, the potential difference between the pixel electrodes and the common electrode is maintained until the next scanning pulse signal is applied to the TFTs. By consecutively providing the scanning signals through the scanning lines and rewriting the gray-scale potentials in the pixels at the frame periods, all the pixels are provided with desired gray-scale potentials for transmission of an image through the LC panel.

In the LC panel, the inherent characteristic of the LC necessitates use of an AC driving technique. The AC driving technique includes a frame-inversion driving scheme wherein the polarity of the data signals applied to the pixel electrodes is inverted at every frame interval, a line-inversion driving scheme wherein the polarity of the data signals is inverted at every source line or every scanning line, and a dot-inversion driving scheme wherein the polarity of the data signals is inverted at every other pixel in the row and column directions. In the line- and dot-inversion driving schemes, the polarity of the data signal applied to each pixel is inverted at every frame interval as in the case of the frame-inversion driving scheme.

LCD devices using a transmissive LC panel include a projection LCD device. The LC panel in the projection LCD device is used as a light valve for optically modulating the light emitted from a light source, and the LC panel is considered as a key device therein, the performance of which determines the performance of the projection LCD device. The projection LCD device is remarkably developed recently to have a higher luminance and a higher contrast ratio, which require a higher opening ratio and a higher contrast ratio for the LC panel or LC light valve.

If the LC light valve is driven in the line-inversion or dot-inversion driving scheme, adjacent pixels, which are adjacent to each other in the row or column direction, are applied with potentials having opposite polarities. Those opposite potentials generate a lateral electric field between the adjacent pixels. In the area wherein the lateral electric field is generated, a disclination occurs wherein the orientation of LC molecules is deviated from the desired orientation. In a normally-white-mode LC light valve, the lateral electric field having a highest level occurs upon display of a dark state, to thereby incur a largest disclination area. In the disclination area, a desired LC orientation cannot be obtained, thereby generating a leakage light, and a luminance increase upon display of the dark state to degrade the contrast ratio. The luminance upon display of a dark state is hereinafter referred to as black luminance, which is undesirable due to incurring a lower contrast ratio in the LCD device. To avoid such a leakage light, the area shielded by a black matrix or light-shield film may be increased to shield the disclination area. However, the increase of the area shielded by the black matrix reduces the opening ratio, to reduce the total luminance of the pixels.

For prevention of the disclination in the LC layer caused by the lateral electric field, it is generally effective to drive the LC light valve in a frame-inversion driving scheme. In the frame-inversion driving scheme, adjacent pixels are applied with potentials having the same polarity, to thereby reduce the disclination area caused by the lateral electric field. That is, the frame-inversion driving scheme provides suppression of the increase of the black luminance, differently from the line-inversion or dot-inversion driving scheme, even in the case of a narrow area of the black matrix. In short, the frame-inversion driving scheme suppresses reduction of the contrast ratio, and achieves a higher opening ratio to thereby provide a higher luminance and a higher contrast ratio for the projection LCD device.

However, there is a problem in the frame-inversion driving scheme in that the time length from the change of the polarity of the output data signals of the source driver to the start of the charge of the pixels depends on the location of the pixels in the display area, thereby incurring a luminance slope or gradient within the display area of the LC panel. This problem will be detailed hereinafter.

In general, the potential of the pixel electrodes fluctuates toward the potential of the source line due to the leakage current of the TFTs, until the pixel electrodes are applied with a next frame potential having an opposite polarity. The magnitude of the leakage current depends on the difference between the potential of the source line and the potential of the pixel electrodes.

In the LC panel, the pixels to which the data is written immediately after the change of the polarity of the output data signal of the source driver reside for a shorter time length in the state of the opposite polarity where the potential of the source line is opposite to the potential of the pixel electrodes. On the other hand, the pixels to which the data is written after a longer time elapsed from the change of the polarity of the output data signal of the source driver reside in the state of the opposite polarity for a longer time length. Thus, the pixels to which data is written after a longer time elapsed from the polarity inversion of the output data signal of the source driver has a larger leakage current, whereby the pixel electrodes have different potentials depending on the order of writing the data signals into the pixel electrodes, even if the pixels electrodes are applied with the same potential.

It is assumed here that a normally-white-mode LC panel displays a dark state in the frame-inversion driving scheme. In this case, the pixel electrodes to which data is written immediately before the change of polarity of the output data signals of the source driver has a black luminance which is higher than the black luminance of other pixel electrodes to which data is written immediately after the change of the polarity of the output data signal of the source driver. As described heretofore, the frame-inversion driving scheme incurs a difference in the black luminance between the pixels to generate a luminance gradient on the panel due to the ununiform black luminance.

Patent Publication JP-1999-102172A describes a technique solving the problem of the luminance gradient to improve the image quality by dividing the entire screen area into a top area and a bottom area, which are driven by respective gate drivers. FIG. 16 shows the LCD device described in the patent publication. The LCD driver 200 includes a first gate driver 203a and a first source driver 202a which are disposed to drive the pixels in the top area, and a second gate driver 203b and a second source driver 202b which are disposed to drive the pixels in the bottom area.

It is assumed here that the gate drivers 203a, 203b scan the gate lines in the order from gate lines G0a, G0b toward gate lines G3a, G3b in the LCD device 200 by using scanning signals. In this case, the pixels connected to scanning lines G3a, G3b selected by the gate drivers 203a, 203b at the last have a larger leakage current compared to the pixels connected to scanning lines G0a, G0b, whereby the pixels nearer to the bottom of the screen in each of the top area and the bottom area have a higher luminance.

As a result, pixels connected to scanning line G3a and having a higher luminance are disposed adjacent to pixels connected to scanning line G0b and having a lower luminance, across the boundary between the top area and the bottom area. That is, there is a problem in that a seam line appears at the boundary between the top area and the bottom area during display of a dark state although such a seam is not observed in normal cases.

The invention described in the patent publication solves the above problem by using a driving scheme wherein the first gate driver 203 scans the gate lines downward from gate lines G0a toward G3a whereas the second gate driver scans the gate lines upward from gate line G3b toward G0b, or a vice versa. This allows the pixels disposed in both areas near the boundary to have similar leakage currents of TFTs, thereby preventing a seam from being observed in the vicinity of the boundary.

The technique described in the above patent publication solves the problem of the seam observed near the boundary. However, the technique cannot solve the aforementioned problem of the luminance gradient in each of the top and bottom areas caused by the order of scanning the gate lines by the gate drivers 203a, 203b.

### SUMMARY OF THE INVENTION

In view of the above problems in the conventional techniques, it is an object of the present invention to provide a LC panel using a frame-inversion driving scheme, which is capable of preventing a luminance gradient caused by the scanning order of the pixels in the frame-inversion driving scheme.

It is another object of the present invention to provide a projection LCD device including such a LC panel.

The present invention provides a liquid crystal (LC) panel including: an active-matrix substrate including a plurality of scanning lines extending in a row direction, a plurality of source lines extending in a column direction, an array of pixels defining a display area and each disposed in a vicinity of an intersection between one of the scanning lines and one of the source lines, each of the pixels including a pixel electrode and an active element; a counter substrate including a common electrode opposing the pixel electrodes of the array of pixels; a LC layer sandwiched between the active-matrix substrate and the counter substrate; a source driver disposed in a vicinity of an edge of the display area for driving the source lines in a frame-inversion driving scheme to write pixel data in the pixels; and a gate driver for driving the scanning lines, wherein the gate driver scans the scanning lines in a scanning order from one of the scanning lines nearest to the source driver toward another of the scanning lines farthest from the source driver in each frame, whereby the source driver writes the pixel data in the pixels in the scanning order.

The present invention also provides a projection LCD device including a light source, the LC panel of the present invention for transmitting light emitted by the light source, and a projection unit for projecting light transmitted by the LC panel onto a screen.

In accordance with the LC panel and the projection LCD device of the present invention, at least some of the luminance gradient caused by the frame-inversion driving scheme can be cancelled by the luminance gradient caused by the heat generated by the source driver, to thereby achieve a uniform luminance in the LC panel.

The above and other objects, features and advantages of the present invention will be more apparent from the following description, referring to the accompanying drawings.

### BRIEF DESCRIPTION OF THE DRAWINGS

FIG. 1 is a schematic top plan view of a LC panel according to a first embodiment of the present invention.

FIG. 2 is a sectional view taken along line II-II in FIG. 1.

FIG. 3 is a schematic top plan view of a LC panel according to a second embodiment of the present invention.

FIG. 4 is a sectional view taken along line IV-IV in FIG. 3.

FIG. 5 is an enlarged sectional view showing the vicinity of the source driver IC shown in FIG. 3.

FIG. 6 is a sectional view taken along line VI-VI in FIG. 3.

FIG. 7 is a schematic top plan view of a LC panel according to a third embodiment of the present invention.

FIG. 8 is an enlarged sectional view showing the vicinity of the source driver IC shown in FIG. 7.

FIG. 9 is a sectional view taken along line IX-IX in FIG. 7.

FIG. 10 is a schematic top plan view of a LC panel according to a fourth embodiment of the present invention.

FIG. 11 is an enlarged sectional view showing the vicinity of the source driver IC shown in FIG. 10.

FIG. 12 is a schematic top plan view of a LC panel according to a first modification from the first embodiment.

FIG. 13 is a schematic top plan view of a LC panel according to a second modification from the first embodiment.

FIG. 14 is a schematic top plan view of a LC panel according to a third modification from the first embodiment.

FIG. 15 is a schematic top plan view of a projection LCD device according to a fifth embodiment of the present invention.

FIG. 16 is a schematic top plan view of a conventional LCD device.

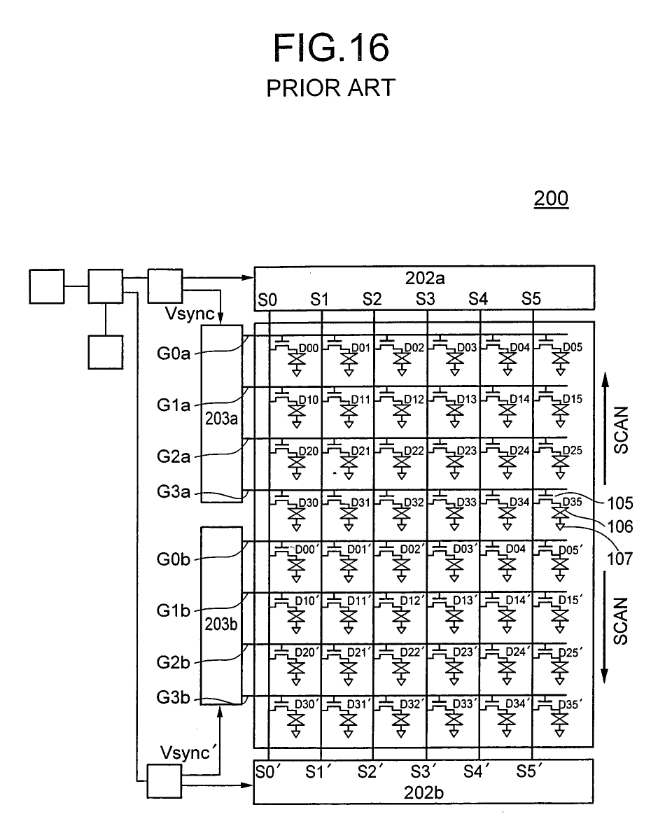

### PREFERRED EMBODIMENT OF THE INVENTION

Now, the present invention is more specifically described with reference to accompanying drawings, wherein similar constituent elements are designated by similar reference numerals throughout the drawings.

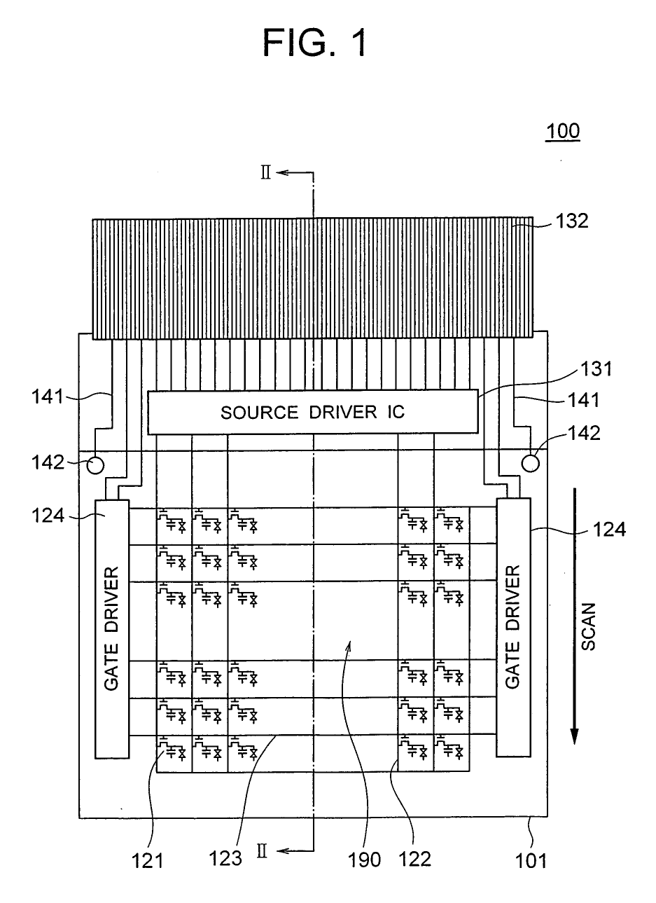

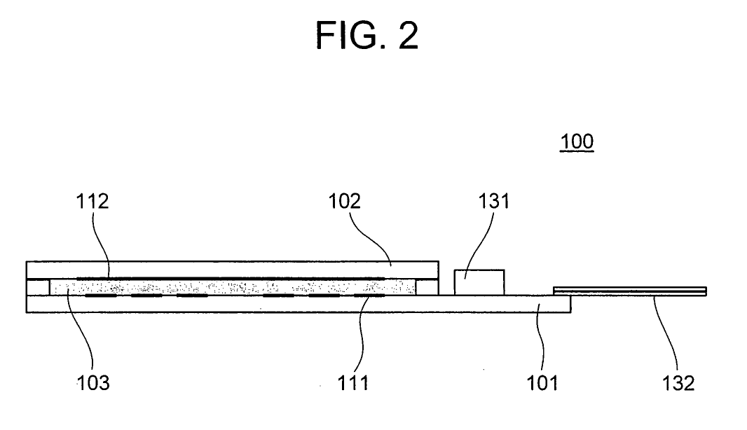

FIG. 1 shows a LC panel according to a first embodiment of the present invention, and FIG. 2 shows a sectional view taken along line II-II in FIG. 1. In FIG. 2, the LC panel, generally designated by numeral 100, includes a TFT substrate 101 on which an array of TFTs are disposed corresponding to pixel electrodes 111, a counter substrate 102 on which a common electrode 112 is disposed to oppose the pixel electrodes 111, and a LC layer 103 sandwiched between the TFT substrate 101 and the counter substrate 102. The LC panel 100 is used as a light valve for modulating the light emitted from a light source to provide an image to a projector.

In FIG. 1, a plurality of source lines 122 extending in a column direction and a plurality of scanning lines 123 extending in a row direction are disposed on the TFT 101, to define an array of pixels in a display area 190. Each pixel is formed in the vicinity of an intersection between one of the scanning lines 123 and one of the source lines 122. Each pixel includes a TFT 121 having a gate connected to one of the scanning lines 123, and a pixel electrode 111 (FIG. 2) connected to one of the source lines 122 via a corresponding TFT 121.

A source driver IC 131 is mounted on a top edge of the TFT substrate 101 near the display area 190 by using a COG(chip-on-glass)-mounting technique, to apply data signals or gray-scale potentials corresponding to gray-scale images to the source lines 122. A pair of gate drivers 124 generate scanning pulse signals to scan the scanning lines 123. The TFTs 121 connected to a scanning line 123 are turned ON by a scanning pulse to write the gray-scale potentials supplied from the source lines 122 into the respective pixel electrodes 111. Each pixel drives a corresponding portion of the LC layer 103 based on the resultant potential difference between the pixel electrodes 111 and the common electrode 112, thereby controlling the optical transmittance of the portion of the LC layer to display an image in the display area 190.

A flexible cable 132 is connected onto the exposed edge portion of the TFT substrate 101 for supplying external signal to the TFT substrate 101. The gate drivers 124 and source driver IC 131 receive external signals from the flexible cable 132 and interconnects 141 formed on the TFT substrate 101. The common electrode 141 receives a signal potential via the flexible cable 132, interconnects 141 and transfer electrodes 142.

The LC panel 100 is driven in a frame-inversion driving scheme, wherein all the data signals written into the pixel electrodes 111 have the same polarity with respect to the common electrode 112 in a single frame period. In addition, the polarity of all the data signals written into the pixel electrodes 111 is inverted at a frame interval between frames. In each frame period, the gate drivers 124 scan the scanning lines 123 consecutively from the scanning line nearest to the edge of the display area 190 at which the source driver IC 131 is COG-mounted on the TFT substrate 101 toward the scanning line farthest from the edge.

In general, in a LC panel using a fame-inversion driving scheme, the pixel electrode for which the scan is performed later in each frame incurs a larger leakage current to experience a larger potential fluctuation. Thus, if the LC panel 100 displays a dark state in a normally-white mode, and if the scanning lines 123 are scanned from the top scanning line nearest to the top edge at which the source driver IC 131 is COG-mounted, the pixel electrodes 111 located near the bottom edge in the display area 190 have a larger leakage current through the TFTs 121 to thereby increase the black luminance.

According to the experiment conducted by the inventors, a LC light valve having a 768 (horizontal)×1024 (vertical) pixel array, known as a XGA LC panel, exhibited an about 10% increase in the black luminance at the bottom pixels compared to the top pixels when the frame-inversion driving scheme scanned from the top pixels toward the bottom pixels at a frame frequency of 60 Hz.

The source driver IC 131 COG-mounted on the TFT substrate 101 generates heat during driving the LC panel 100, thereby raising the temperature of the TFT substrate 101 and counter substrate 102 at the vicinity of the source driver IC 131. Thus, the glass substrate body configuring each of the TFT substrate 101 and counter substrate 102 has a temperature gradient within the display area 190, wherein a portion of the glass substrate body located farther from the source driver IC 131 has a lower temperature rise. That is, the temperature gradient follows the direction of the scanning for the scanning lines 123.

Thus, the glass substrate body has a retardation depending on the temperature rise to thereby change the optical transmittance thereof. Upon display of a dark state by a LC panel operating in a normally-white mode, the pixels disposed nearer to the source driver IC 131 have a higher black luminance due to the higher optical transmittance. According to the simulation conducted by the inventors for an XGA LCD panel, the pixels nearest to the source driver IC 131 had an about 2% increase in the black luminance compared to the pixels farthest from the source driver IC 131 when a calorific power corresponding to the calorific power of the source driver IC 131 operating at a frame frequency of 60 Hz is supplied in the simulation.

Upon display of a dark state by the LC panel 100 operating in a normally-white mode, for example, the temperature rise of the glass substrate body incurs an increase in the black luminance of the pixels disposed in the vicinity of the source driver IC 131 due to the retardation. On the other hand, the pixels disposed far from the source driver IC 131 experience an increase in the black luminance due to the potential fluctuation of the pixel electrodes 111 caused by the frame-inversion driving scheme.

In the present embodiment, the scanning lines 123 are driven consecutively from the scanning line nearest to the source driver IC 131, where the glass substrate body has a highest temperature rise, toward the pixels farthest from the sour driver IC 131, where the glass substrate body has a lowest temperature rise. This allows both the increases in the black luminance caused by the temperature rise and frame-inversion driving scheme to cancel each other between the top area and the bottom area of the display area 190. Thus, a projection LCD device including the LC panel 100 of the present embodiment achieves a more uniform black luminance.

Typical LC panels generally use a frame frequency of about 60 to 75 Hz. The frame-inversion driving scheme used in this frequency range may experience a flicker caused by the leakage current of the TFTs due to the potential difference between pixels, thereby degrading the image quality of the LC panel. For avoiding degradation of the signal quality caused by the frame-inversion driving scheme, it is preferable that a higher frame frequency up to 120 Hz or above be employed.

The calorific power of the source driver IC 131 is increased along with the increase in a frame frequency, or operation speed, of the LC panel 100. Upon display of a dark state by a LCD device including a XGA LC panel operating in a normally-white mode at a frame frequency of 180 Hz, which is about triple the normal frame frequency, the black luminance of the pixels nearest to the source driver IC was higher by about 9% compared to the pixels farthest from the source driver IC 131. Thus, a higher frame frequency incurs a higher temperature difference between the pixels nearest to the source driver IC and the pixels farthest from the source driver IC, whereby the higher frame frequency provides a more uniform optical transmittance.

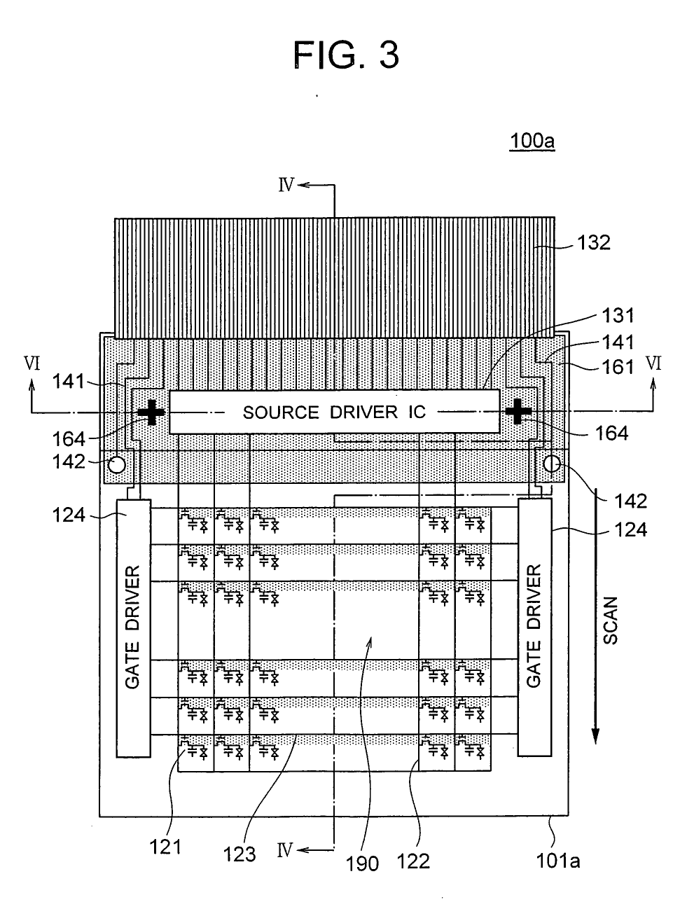

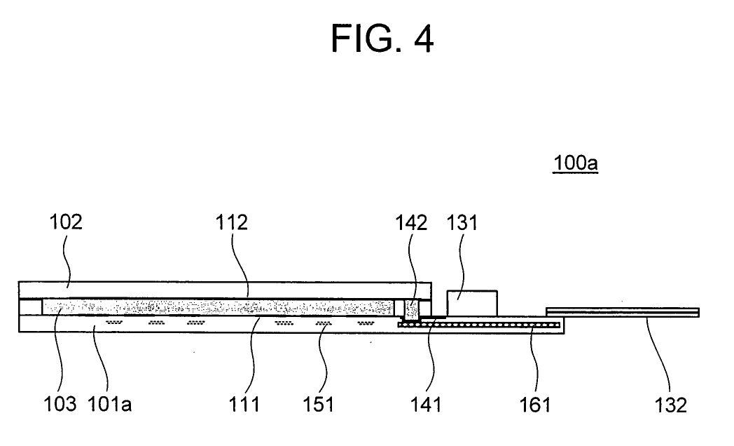

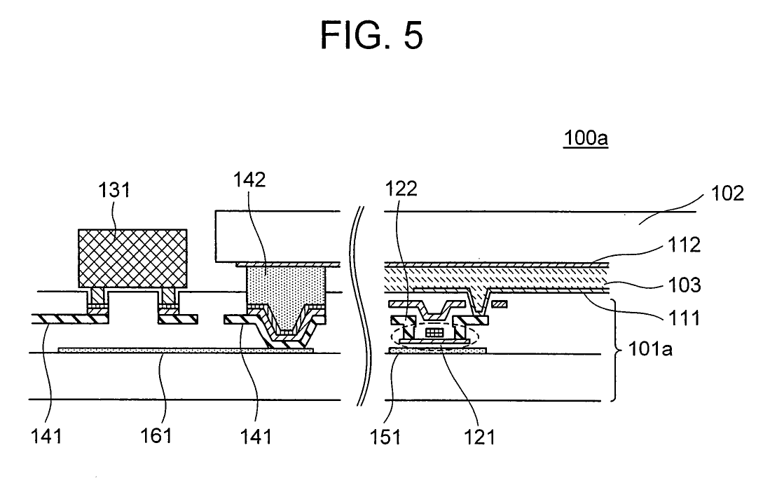

FIG. 3 shows a LC panel according to a second embodiment of the present invention. FIG. 4 is a sectional view taken along line IV-IV in FIG. 3, and FIG. 5 shows the detail of a portion of FIG. 4 in the vicinity of the source driver IC and a TFT. The LC panel 100a of the present embodiment is similar to the LC panel 100 of the first embodiment except that a radiator film 161 is embedded in the TFT substrate 101a as a heat adjusting element at the location underlying the source driver IC 131 in the present embodiment. The radiator film 161 is configured from a metallic material, such as tungsten or tungsten silicide, which configures a light-shield film 151 for shielding the TFTs against light.

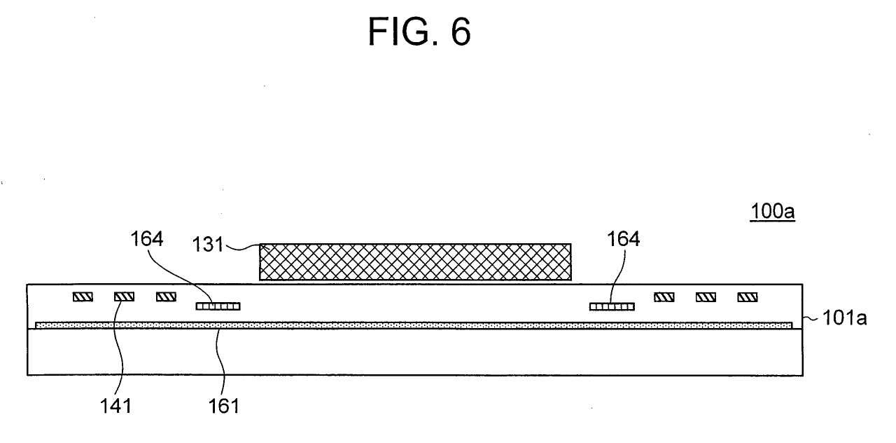

FIG. 6 is a sectional view taken along line VI-VI in FIG. 3. The radiator film 161 is disposed at the location of the TFT substrate 101a where the source driver IC 131 transfers a large amount of calorific power to the glass substrate body. The radiator film 161 is coupled to the common electrode 112 via the interconnects 141 and transfer electrodes 142, as shown in FIG. 5, thereby radiating the heat from the source driver IC 131 to the counter substrate 102.

The radiator film 161 has thereon alignment marks 164 used for positioning the source driver IC 131. The alignment marks 164 are formed by patterning a chrome film in the step of forming gate electrodes of the TFTs, or by patterning an aluminum film in the step of forming interconnects 141.

In the LC panel 100 of the first embodiment, if the source driver IC 131 generates an excessively large amount of heat, the luminance gradient caused by the heat generated in the source driver IC 131 may be larger than the luminance gradient caused by the frame-inversion driving scheme. In this case, both the luminance gradients caused by the temperature rise and the frame-inversion driving scheme are cancelled only in a limited amount. On the other hand, in the LC panel 100a of the present embodiment, since the radiator film 161 discharges the heat generated in the source driver IC 131 to reduce the luminance gradient caused by the temperature rise, both the luminance gradients can be made equivalent to each other by selecting a suitable radiation capacity of the radiator film 161 by selecting the size or heat conductivity of the radiator film 161. The present embodiment is more effective for a LC panel to operate at a higher frame frequency.

The radiator film 161 should be preferably made of a material having a light shield function and thus shield the source driver IC 131 against light. This prevents a malfunction of the source driver IC 131 caused by irradiation of light thereto. The alignment marks 164 should be preferably made of a material having a reflectivity different from the reflectivity of the material configuring the radiator film 161. The source driver IC 131 can be positioned with ease by using such alignment marks.

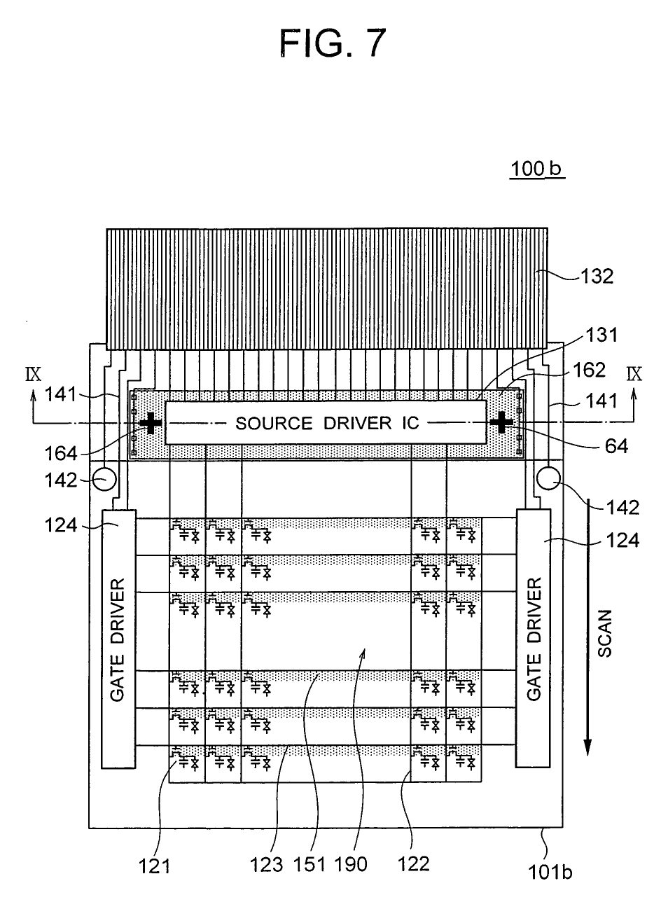

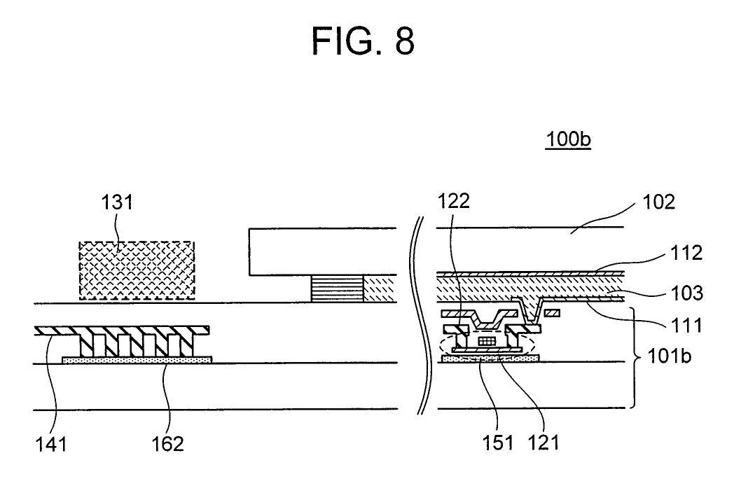

FIG. 7 shows a LC panel according to a third embodiment of the present invention. FIG. 8 is a sectional view showing the detail of the vicinity of the source driver IC and a TFT, similarly to FIG. 5. In the present embodiment, the radiator film 161 in the second embodiment is replaced by a heater or resistor film 162 provided as a heat adjusting element. Other configurations are similar to those in the second embodiment. The resistor film 162 is made of a metallic material, such as tungsten or tungsten silicide, configuring the light shield layer 151, and has a resistance of several to several hundreds of ohms.

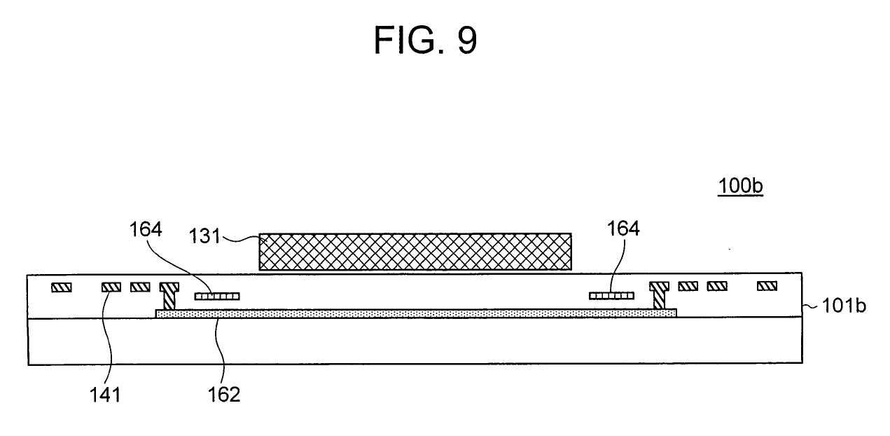

FIG. 9 is a sectional view taken along line IX-IX in FIG. 7. The resistor film 162 is connected to power source lines via the interconnects 141 and flexible cable 132, and is applied with a specific voltage between both the terminals thereof. The resistor film 162 has thereon alignment marks 164 similarly to the resistor film 162 in the second embodiment, for positioning of the source driver IC 131.

In the LC panel 100 of the first embodiment, if the source driver IC 131 generates an excessively small amount of heat, the luminance gradient caused by the temperature rise may be smaller than the luminance gradient caused by the frame-inversion driving scheme. In this case, both the luminance gradients caused by the temperature rise and the frame-inversion driving scheme are scarcely cancelled by each other. On the other hand, in the LC panel 100b of the present embodiment, since the resistor film 162 generates heat to increase the luminance gradient caused by the temperature rise, both the luminance gradients can be made equivalent to each other by selecting a suitable heating capacity for the resistor film 162, such as by selecting the resistance or applied voltage of the resistor film 162. The present embodiment is more effective in a LC panel operating at a higher frame frequency up to 120 Hz or above.

The resistor film 162 should be preferably made of a material having a light shield function and thus shield the source driver IC 131 against light. This prevents a malfunction of the source driver IC 131 caused by irradiation of light thereto. The alignment marks 164 should be preferably made of a material having a reflectivity different from the reflectivity of the material configuring the resistor film 162. The source driver IC 131 can be positioned with ease by using such alignment marks.

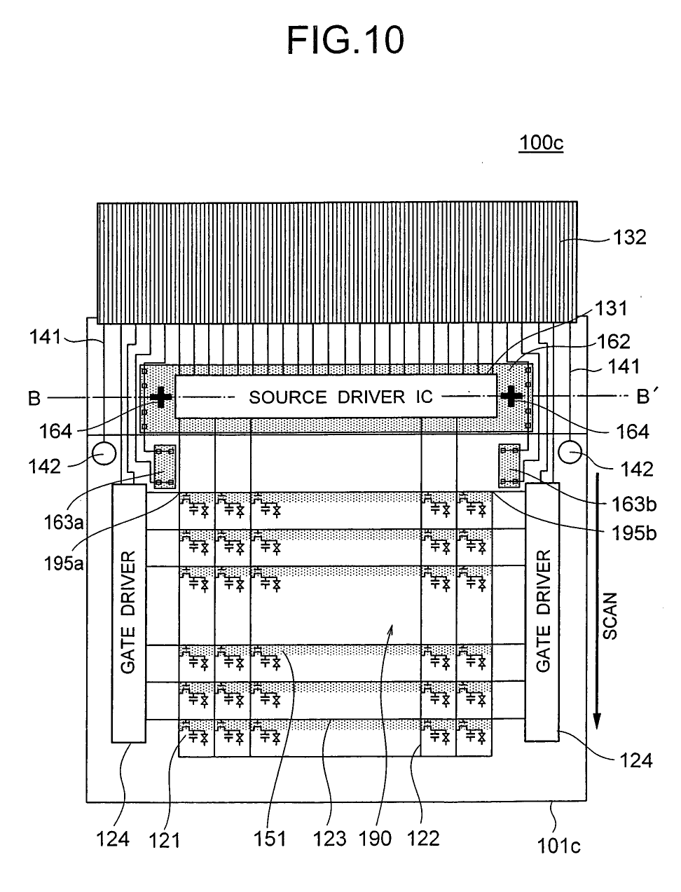

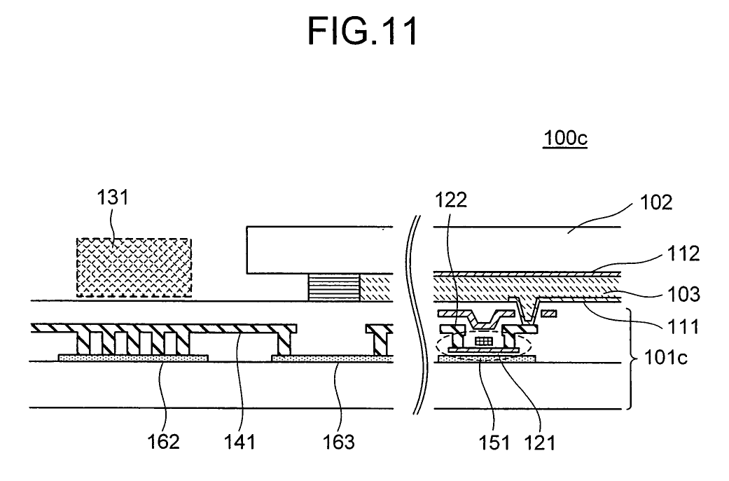

FIG. 10 shows a LC panel according to a fourth embodiment of the present invention. FIG. 11 is a sectional view showing the vicinity of the source driver IC and a TFT, similarly to FIG. 5. The LC panel 100c of the present embodiment includes additional heaters or resistor films 163a, 163b in addition to a resistor film 162 as used in the third embodiment. The additional resistor films 163a, 163b are disposed in the vicinity of the top corners of the display area 190. The additional resistor films 163a, 163b are made of the same material as the resistor film 162.

The additional resistor films 163a, 163b are connected to power source lines via interconnects 141 and flexible cable 132, similarly to the resistor film 162. The additional resistor films 163a, 163b may be connected in series or in parallel between the power source lines.

In the present embodiment, the additional resistor films 163a, 163b heat the end portions of the source driver IC 131 and the resistor film 162, the end portions having a temperature rise lower than the temperature rise of the central portion of the source driver IC 131 and the resistor film 162, to obtain a more uniform temperature rise. The resistor films 163a, 163b assist the source driver IC 131 and resistor film 162 to provide a more uniform temperature rise in the display area 190 especially in the horizontal direction.

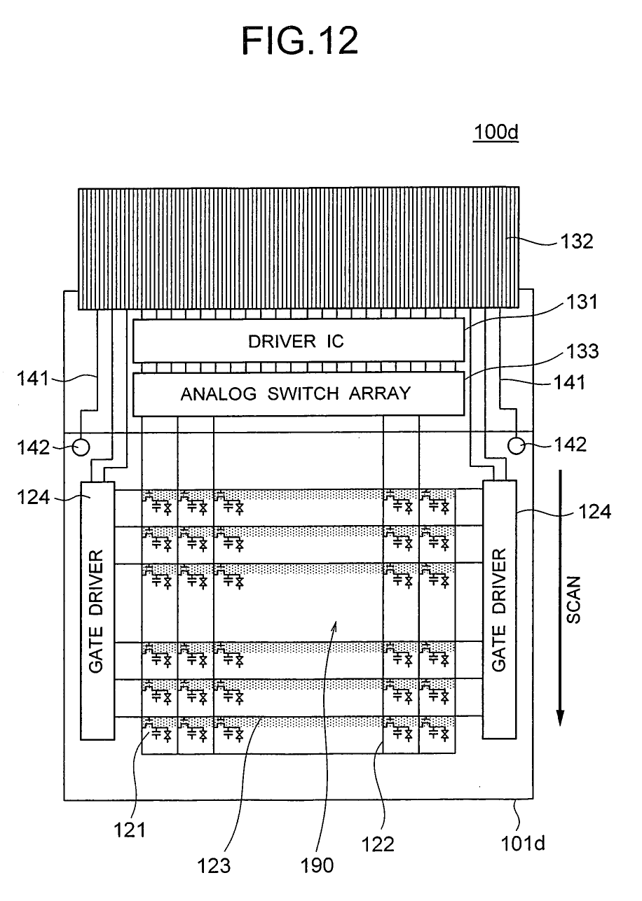

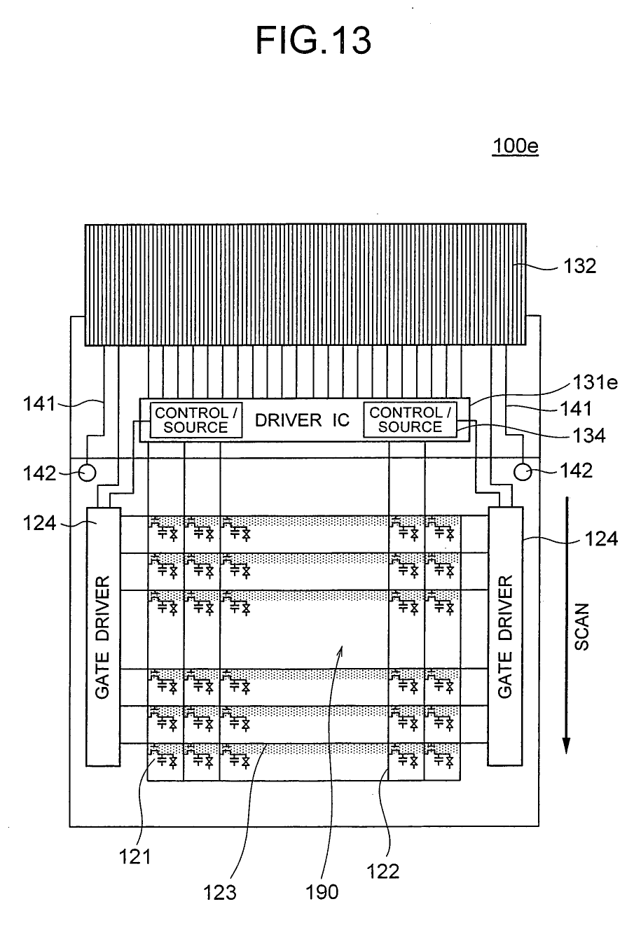

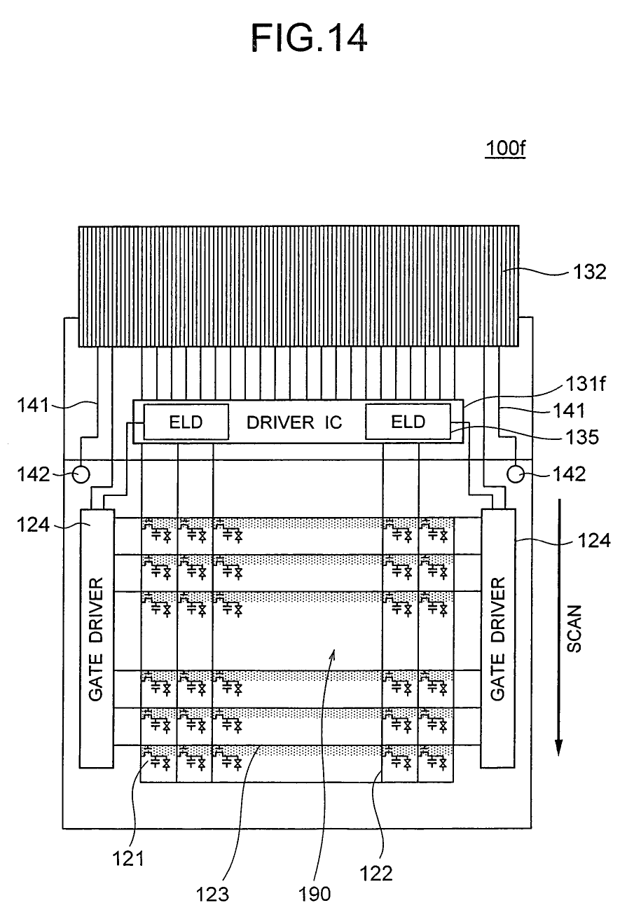

In the LC panels of the above embodiments, the gate drivers 124 driving the scanning lines 123 are installed in the TFT substrate 101, and the source driver IC 131 driving the source lines 122 is COG-mounted on the TFT substrate 101. However, as shown in FIG. 12, an analog switching array 133 may be installed in the TFT substrate 101 in addition to the source driver IC 131 for driving the source lines 122. In an alternative, as shown in FIG. 13, control/power source sections 134 for generating control pulses may be installed in the source driver IC 131e. As a further alternative, as shown in FIG. 14, electrostatic protective devices (ESDs) 135 for protecting the gates of TFTs against a electrostatic discharge failure may be installed in the source driver IC 131f instead of installation in the gate drivers 124.

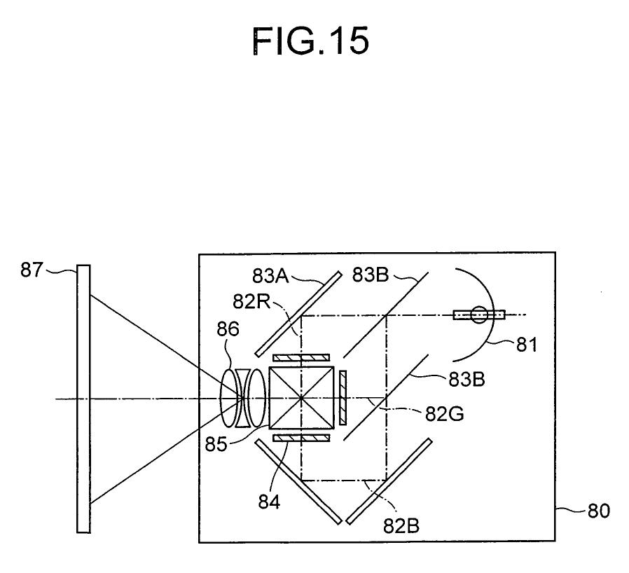

The LC panel of the present invention may be used in a typical LCD device or may be installed in a projection LCD device. FIG. 15 exemplifies such a projection LCD device. The projection LCD device, generally designated by numeral 80, includes three LC panels 84 as light valves of the projection LCD device 80. More specifically, the projection LCD device 80 includes a halogen lamp 81 as a light source, a color separator system for separating the light emitted from the halogen lamp 81 into three primary color fluxes including red, green and blue light fluxes 82R, 82G and 82B, and three LC light vales 84, a color synthesis system for synthesizing the three color fluxes after passing through the three LC light valves 84, and a projection optical system including a projection lens 86 for achieving an extended projection of the image. The color separator system includes a mirror 83A, dichroic mirror 83B etc., whereas the color synthesis system includes a dichroic prism 85 etc. Each of the LC light valves 84 is one of the transmissive LC panels of the first through fourth embodiments.

It is to be noted that the present invention is not limited to a LC panel for use in a projection LCD device, and may be applied to a general LC panel on which the desired image is displayed. The term LC panel in the text includes LCD panel.

Since the above embodiments are described only for examples, the present invention is not limited to the above embodiments and various modifications or alterations can be easily made therefrom by those skilled in the art without departing from the scope of the present invention.

What is claimed is:

1. A liquid crystal (LC) panel comprising:
an active-matrix substrate including a plurality of scanning lines extending in a row direction, a plurality of source lines extending in a column direction, an array of pixels defining a display area and each disposed in a vicinity of an intersection between one of said scanning lines and one of said source lines, each of said pixels including a pixel electrode and an active element;
a counter substrate including a common electrode opposing said pixel electrodes of said array of pixels;
a LC layer sandwiched between said active-matrix substrate and said counter substrate;
a source driver disposed in a vicinity of an edge of said display area for driving said source lines in a frame-inversion driving scheme to write pixel data in said pixels; and
a gate driver for driving said scanning lines, wherein:
said gate driver scans said scanning lines in a scanning order from one of said scanning lines nearest to said source driver toward another of said scanning lines farthest from said source driver in each frame, whereby said source driver writes said pixel data in said pixels in said scanning order.

2. The LC panel according to claim 1, further comprising a heat adjusting element disposed in a vicinity of said source driver for radiating or generating heat from/in said active-matrix substrate.

3. The LC panel according to claim 2, wherein said heat adjusting element is made of a light-shield material.

4. The LC panel according to claim 3, wherein said heat adjusting element is formed as a common layer with a light-shield film shielding said active element.

5. The LC panel according to claim 2, further comprising an alignment mark overlapping said heat adjusting element as viewed normal to said active-matrix.

6. The LC panel according to claim 1, wherein a luminance gradient caused by heat generated by said source driver on said active-matrix substrate is substantially equal to a luminance gradient caused by said scanning order.

7. The LC panel according to claim 1, wherein said source driver writes data at a frame frequency of 120 Hz or higher.

8. The LC panel according to claim 1, wherein said source driver is chip-on-glass-mounted on said active-matrix substrate.

9. The LC panel according to claim 2, wherein said heat adjusting element is embedded in said active-matrix substrate at a location underlying said source driver.

10. The LC panel according to claim 2, wherein said heat adjusting element includes a radiator thermally coupled to said common electrode to radiate heat generated by said source driver toward said counter substrate.

11. The LC panel according to claim 1, wherein said heat adjusting element includes a first heater.

12. The LC panel according to claim 11, wherein said heat adjusting element further includes a pair of second heaters disposed in a vicinity of pixels connected to both ends of said one of said scanning lines.

13. A projection-type liquid crystal display device comprising a light source, said LC panel according to claim 1 and transmitting light emitted by said light source, and a projection unit for projecting light transmitted by said LC panel onto a screen.
